(19) United States
(12) Patent Application Publication
(10) Pub. No.: US 2026/0341154 A1
(43) Pub. Date: Oct. 29, 2026

(54) Pedestrian Awareness and Safety Alert System for Vehicle Interaction Zones

(71) Applicants: GIUSEPPE COVELLO, Upper Freehold, NJ (US); Brian Baslin, Upper Freehold, NJ (US)

(72) Inventors: GIUSEPPE COVELLO, Upper Freehold, NJ (US); Brian Baslin, Upper Freehold, NJ (US)

(21) Appl. No.: 19/190,846

(22) Filed: Apr. 28, 2025

(51) Int. Cl. G08G 1/16; G07C 9/15; G08B 7/06; G08B 21/02

(52) U.S. Cl. CPC G08G 1/166; G07C 9/15; G08B 7/06; G08B 21/02

(57) ABSTRACT

A modular pedestrian awareness system is disclosed for detecting vehicular movement near pedestrian zones and generating real-time alerts to enhance safety in commercial environments such as construction sites and parking garages. The system comprises a sensor array for detecting vehicle motion, a processing unit configured to classify vehicular activity, and an alert module incorporating visual and audible warning mechanisms. The system supports configurable detection zones, adaptive alert intensity, and environmental calibration features such as ambient light and noise compensation. Power is provided via AC, battery, or solar sources, and the system may include wireless or wired communication interfaces for remote monitoring and integration with access control systems. The modular design enables scalable deployment, field upgrades, and varied mounting configurations, including fixed and mobile installations. The system supports automated escalation logic based on threat proximity and may include pedestrian detection for bidirectional hazard assessment.

### BACKGROUND OF THE INVENTION

### Field of Invention

The present invention relates generally to pedestrian safety systems and, more particularly, to automated pedestrian awareness and warning systems designed for deployment at commercial establishments, such as construction sites, parking garages, and similar vehicle interaction zones. The invention pertains to the field of safety alert mechanisms incorporating audio, visual, and sensor-based technologies configured to detect vehicle movement and provide timely alerts to pedestrians in the vicinity.

### BRIEF SUMMARY OF THE INVENTION

The present invention, designated as “Clear Path,” is a modular pedestrian awareness and safety alert system configured to reduce the risk of pedestrian-vehicle collisions in and around commercial establishments. The system utilizes a combination of detection sensors, audible alarms, and visual alert mechanisms to notify pedestrians of approaching or departing vehicles, particularly at entry and exit points of construction sites, parking garages, and other high-traffic environments.

Clear Path operates manually or autonomously and can be customized to suit specific site conditions. Its components may include motion detectors, flashing lights, loudspeakers, and integrated warning signs, all of which can be deployed in various configurations. The system is designed for flexible installation-wall-mounted, pole-mounted, or integrated into existing infrastructure—and may be powered by plug-in, battery, or solar energy sources, thereby providing a scalable and effective pedestrian safety solution.

### BRIEF DESCRIPTION OF THE FIGURES

FIG. 1 illustrates a user interface module comprising a manual activation button and an optional sensor element, housed in a compact enclosure measuring approximately 2 13/16 inches by 3 ½ inches by 4 ½ inches.

FIG. 2 illustrates an alarm unit containing a visual light element, audible siren, and associated alert components, enclosed within a housing measuring approximately 6 inches by 10 inches by 8 inches.

### DETAILED DESCRIPTION

The present invention, herein referred to as the “Clear Path Pedestrian Awareness System” (hereinafter, “the system”), comprises a modular and integrated safety architecture configured to detect vehicular motion in proximity to designated pedestrian zones and to generate corresponding alert signals to mitigate collision risks. The system is designed to operate autonomously or semi-autonomously and is adaptable to a variety of commercial environments, including but not limited to construction zones, parking garages, loading docks, warehouse access points, and other ingress/egress corridors where vehicle-pedestrian interaction presents a safety hazard.

The system is constituted of multiple discrete and interoperable subsystems, each functioning in concert to accomplish the overarching goal of real-time hazard detection and alert generation. At the core of the system lies a Sensor Array Module, comprising one or more detection units selected from the group consisting of passive infrared (PIR) sensors, ultrasonic range finders, millimeter-wave radar sensors, and computer vision-based optical sensors. These sensors may be arranged in a linear, radial, or overlapping configuration to provide 180-degree or 360-degree surveillance coverage, depending on site requirements. The sensor array is mounted to structural support members via adjustable brackets that allow angulation and vertical calibration to optimize the detection field.

Each sensor within the array is operatively coupled to a Central Processing Unit (CPU) or Embedded Microcontroller Unit (MCU), which performs signal conditioning, noise filtration, and event classification using pre-programmed thresholds and, optionally, machine learning algorithms. The CPU/MCU is configured to receive raw sensor data in real time and execute algorithmic routines to determine whether vehicular movement exceeds predefined risk parameters based on velocity, directionality, proximity to pedestrian paths, and temporal persistence. A memory module, comprising volatile and non-volatile storage, is operatively connected to the CPU/MCU for the purpose of maintaining system firmware, historical log data, calibration values, and event response patterns.

Upon identification of a threshold-crossing vehicular event, the processing unit transmits an activation signal to one or more Alert Mechanisms, which may include visual warning indicators, audible sirens, voice alert modules, and digital signage interfaces. The visual alert subsystem typically consists of high-intensity light-emitting diode (LED) strobes configured to flash in prescribed sequences and color patterns (e.g., red, amber) as dictated by regulatory or situational parameters. The audible alert subsystem may include piezoelectric buzzers, sirens with variable tone sequences, or voice synthesis modules that articulate specific warnings in natural language. In certain embodiments, a combined audiovisual module is housed within a weatherproof enclosure to ensure operability under outdoor environmental conditions, including rain, dust, and temperature fluctuations.

The system further comprises a Mounting and Enclosure Subsystem, which includes modular brackets, support poles, or retrofit kits designed to integrate the device into pre-existing site infrastructure. Enclosures are fabricated from high-durability polymers or powder-coated metals to meet ingress protection standards such as IP65 or NEMA Type 4X, ensuring resilience in adverse environmental conditions. Where necessary, vibration dampeners and shock-absorbing materials may be incorporated to preserve component stability in high-traffic or machinery-adjacent environments.

Power delivery to the system is facilitated via a Power Management Module, which accepts alternating current (AC) mains input or is configured for low-voltage direct current (DC) input from battery packs or photovoltaic (solar) panels. The power management module incorporates overcurrent protection, voltage regulation, and, in certain embodiments, an uninterruptible power supply (UPS) or energy storage buffer to enable system continuity during grid disruptions or maintenance intervals.

Optionally, the architecture may include a Communication Interface Module, comprising short-range and/or long-range wireless communication hardware such as Bluetooth, Wi-Fi, LoRaWAN, or cellular (2G/3G/4G/5G) modems. This module enables remote diagnostics, software updates, and integration with broader safety management systems or access control infrastructures. Wired communication pathways, such as RS-485 or Ethernet, may be employed for latency-sensitive deployments or high-security environments.

Collectively, the described architectural components form a scalable and interoperable safety platform designed to increase situational awareness, reduce human error, and prevent pedestrian injuries in dynamic commercial environments. The modularity of the system facilitates rapid deployment, routine maintenance, and future upgradability, ensuring that the Clear Path system remains viable across evolving site conditions and regulatory landscapes.

The Clear Path Pedestrian Awareness System is engineered to perform continuous surveillance and real-time hazard analysis within designated pedestrian-vehicle interaction zones. The operational functionality of the system is predicated upon its ability to detect motion vectors associated with vehicular movement and to classify such motion as a potential safety threat to proximate pedestrians. This detection-to-alert workflow is governed by a hierarchical event processing logic embedded within the system's firmware and/or executed via an edge-based computing architecture.

Upon system initialization, the sensor array enters an active polling state, during which environmental data is captured at predetermined intervals (e.g., every 100 milliseconds) across multiple sensor modalities. Each sensor unit, whether ultrasonic, radar-based, or vision-enhanced, outputs raw analog or digital signals corresponding to detected movement, distance, and object size. These signals are subjected to signal pre-conditioning, including analog-to-digital conversion, noise suppression filtering (e.g., Kalman filtering or Gaussian smoothing), and timestamping, before being relayed to the Central Processing Unit (CPU) or Microcontroller Unit (MCU) for interpretation.

The core processing logic utilizes a combination of deterministic thresholding and probabilistic object classification algorithms to differentiate between vehicular entities and non-threatening environmental stimuli (e.g., swaying foliage, ambient pedestrian traffic, or lighting variations). For example, vehicular objects are identified based on a convergence of motion trajectory, size dimensions exceeding human scale, speed thresholds typically greater than 2 mph (or site-specified baseline), and infrared or radar signatures consistent with metallic or composite mass bodies. In embodiments leveraging machine learning, the system employs trained convolutional neural networks (CNNs) or support vector machines (SVMs) to classify detected entities, with inference models periodically updated through remote or manual upload.

When a target object is positively identified as a moving vehicle and said object approaches a geofenced “critical zone”—an area dynamically defined by pre-programmed parameters or manual configuration-the CPU executes an interrupt-driven subroutine initiating an alert sequence. The alert is tiered based on proximity, velocity, and directionality of the vehicle relative to known pedestrian paths. For instance, a vehicle crossing into the predefined buffer zone may trigger a Level 1 visual warning (e.g., flashing amber LEDs), while sustained motion toward a pedestrian ingress/egress point may elevate the system response to Level 2 (e.g., strobing red LEDs and 90 dB audible alarms).

The detection mechanism also incorporates hysteresis logic and debounce timing to prevent false triggering caused by intermittent or spurious signals. The system continuously reevaluates the status of the moving object, and in the event that motion ceases or direction reverses away from pedestrian zones, a programmed timeout will deactivate the alert sequence, conserving power and reducing alert fatigue. In some embodiments, the system may also enter a standby state to reduce energy consumption during prolonged inactivity, with wake-up conditions tied to motion detection above a specified threshold.

In addition to vehicle detection, certain configurations of the Clear Path system support pedestrian presence sensing, enabling bidirectional safety logic. For example, if a pedestrian is detected standing near a blind corner or access gate, and a vehicle is simultaneously approaching from the opposite direction, the system may delay or modulate the alert to both parties (e.g., pre-warning for the pedestrian followed by full alert for the vehicle operator). This cross-referencing of pedestrian and vehicle position data enhances situational awareness and enables more intelligent response strategies.

The system also features an event logging subroutine, which records key data points during each detection instance, including timestamps, sensor source, alert level, and duration. These logs may be stored locally or transmitted to a central server for compliance audits, safety analysis, or insurance reporting purposes. The system can be programmed to erase log data at periodic intervals or retain data indefinitely based on memory availability and user requirements.

Importantly, the operational framework of the Clear Path system has been designed to comply with relevant safety and accessibility standards, such as those outlined by the Occupational Safety and Health Administration (OSHA), Americans with Disabilities Act (ADA), and International Electrotechnical Commission (IEC) standards governing visual and auditory alarm systems. This compliance ensures that the system may be deployed in a wide array of regulated environments without requiring extensive site-specific certification or retrofitting.

The Clear Path Pedestrian Awareness System is engineered to function as an intelligent, network-enabled safety platform capable of interoperating with adjacent infrastructure, auxiliary control systems, and remote monitoring services. This section delineates the communication protocols, power systems, and integrative functionalities that enable robust site adaptability and scalability, particularly in the context of commercial and industrial deployment environments where continuity of operation and intersystem compatibility are mission-critical.

### A. Communication Protocols and Data Interface

The system includes an internal Communication Interface Module, configured to enable both intra-system component interaction and inter-system connectivity. The communication architecture is comprised of a multilayered protocol stack supporting both wired and wireless transmission media. On the physical layer, the system may incorporate interfaces including RS-485, RS-232, Controller Area Network (CAN bus), or Ethernet (Cat5e/Cat6), each selected based on deployment scale, environmental robustness, and latency tolerance. For wireless configurations, the system supports Bluetooth Low Energy (BLE), IEEE 802.11-based Wi-Fi, LoRaWAN (Long Range Wide Area Network), Zigbee, and cellular broadband (3G, 4G LTE, or 5G), allowing for secure and real-time remote access to diagnostics, firmware updates, and data telemetry.

The system's firmware includes an Application Programming Interface (API) layer that enables secure handshaking, message encryption, and device authentication using industry-standard protocols such as HTTPS, MQTT, or Modbus TCP/IP. This allows seamless interfacing with centralized monitoring dashboards, Building Management Systems (BMS), Supervisory Control and Data Acquisition (SCADA) systems, or third-party access control platforms. The API facilitates data transmission of system health metrics, real-time alert states, and logged detection events, while simultaneously allowing authorized administrators to reconfigure system parameters remotely or initiate soft reboots and self-diagnostic sequences.

Additionally, the system may include onboard memory storage (e.g., SD card or eMMC module) that buffers telemetry data during network outages or when operating in a “disconnected” mode. In such scenarios, stored data is automatically pushed to the remote system upon network re-establishment. The communication subsystem also allows for over-the-air (OTA) firmware updates, which may be scheduled or triggered manually, ensuring that the system benefits from ongoing security patches, feature enhancements, and calibration refinements.

### B. Power Systems and Energy Management

Power delivery to the system is orchestrated through a Power Management Module, engineered to accommodate diverse energy sources while ensuring operational stability under fluctuating supply conditions. The primary mode of power input may be an alternating current (AC) source in the 110V-240V range, routed through a step-down transformer and rectifier circuit to deliver low-voltage direct current (DC) suitable for sensitive electronic components. The system is further equipped with voltage regulators and power conditioning units to protect against surges, brownouts, and harmonic distortions commonly present in industrial power networks.

In remote or off-grid deployments, the system supports battery-based and solar photovoltaic (PV) power options. The solar configuration integrates a charge controller that regulates current flow to a sealed lead-acid or lithium-ion energy storage module, with capacity scaled according to projected duty cycles and climate factors. Where site conditions are dynamic or installation mobility is required, a hybrid configuration may be employed, combining grid power with solar or battery backups and configured to automatically switch between sources based on availability and priority.

For mission-critical applications, the system optionally incorporates an Uninterruptible Power Supply (UPS) subsystem, which allows the system to remain functional for a defined buffer period during a grid outage. This feature ensures continuous monitoring and alert capability, thereby maintaining compliance with site safety protocols even during emergency conditions.

### C. Integration Capabilities with External Systems

The modular and standards-based design of the Clear Path system facilitates seamless integration into both legacy and next-generation safety ecosystems. Through its flexible input/output (I/O) architecture, the system may be interfaced with external actuators, gate controllers, CCTV systems, and audible public address networks. For instance, upon vehicular detection, the system can trigger gate delays, override pedestrian signal lights, or notify centralized command via audible or visual indicators integrated into the broader control matrix.

The system can be configured to interface with industrial Internet of Things (IIoT) platforms, allowing real-time data to be leveraged in predictive analytics and workflow optimization. For example, detection frequency data can be analyzed to optimize site traffic patterns or to inform dynamic reallocation of pedestrian access points. When integrated with Video Management Systems (VMS), the system can act as a trigger event initiator, causing security cameras to pan or zoom toward areas of concern upon detection of vehicular movement near pedestrian walkways.

The system also supports conditional integration with emergency response protocols, wherein alert events may be tied into fire control panels, evacuation systems, or mobile notification platforms. In such embodiments, the detection of abnormal vehicular motion—such as a vehicle moving in a restricted direction—may trigger a cascade of events beyond the Clear Path system itself, such as lockdown of nearby gates, activation of directional signage, or dispatch of safety personnel.

The communication, power, and integration subsystems of the Clear Path Pedestrian Awareness System are designed to ensure that the platform is not only self-sufficient and operationally resilient but also interoperable with a wide spectrum of commercial safety infrastructures. This enables scalable deployment, enhances user configurability, and supports long-term lifecycle management in complex and evolving urban and industrial environments.

The Clear Path Pedestrian Awareness System is designed to ensure intuitive, responsive, and context-aware interaction with end users, specifically pedestrians, site personnel, and system operators. The system utilizes a multi-modal human-machine interface to deliver real-time alerts through visual and auditory channels, thereby accommodating diverse sensory conditions common to high-traffic commercial zones. Visual alerts are generated by high-intensity LED modules, which may be configured in various geometric arrays and programmed to flash in standardized color sequences—typically red, amber, or white—consistent with regulatory norms for hazard indication. These visual signals are optimized for visibility in both well-lit and low-light environments and are enclosed within vandal-resistant, weather-sealed housings to maintain long-term performance integrity. In parallel, auditory alerts are generated using either high-decibel buzzers or pre-recorded voice prompts, with the added capability of utilizing a synthesized speech engine to articulate dynamic warnings. Volume levels are automatically modulated in response to ambient noise measurements obtained through integrated acoustic sensors, ensuring intelligibility without exceeding permissible sound exposure thresholds under occupational safety guidelines.

User interaction is further enhanced by the inclusion of a local or remote operator interface, which may be provided in the form of a touchscreen control panel, web-based dashboard, or mobile application. This interface allows authorized users to initiate system diagnostics, monitor real-time operational status, adjust detection thresholds, override alerts manually, or schedule firmware updates. Access to the interface is typically secured through multi-factor authentication or role-based credentials, ensuring that only designated personnel may perform configuration or administrative functions. Additionally, the user interface may provide visualization of detection zones, historical alert logs, system health indicators, and connectivity status, facilitating routine inspections, compliance audits, and safety performance reviews.

The system has been engineered for exceptional adaptability across variable environmental conditions commonly found at commercial and industrial deployment sites. LED modules are equipped with ambient light sensors that dynamically adjust brightness levels, ensuring maximum visibility without inducing glare during daylight hours or excessive luminosity in dim environments. The auditory subsystem is designed to overcome background noise interference through real-time signal amplification calibrated against ambient decibel readings. In locations where traditional alert modalities may be insufficient or prohibited, the system supports supplemental notification pathways, including haptic feedback devices or Bluetooth-linked wearables, enabling site-specific safety protocols to extend to hearing-impaired or sensory-sensitive individuals.

To accommodate the diverse spatial layouts and pedestrian flow patterns characteristic of modern commercial sites, the system supports dynamic zoning capabilities. Detection zones may be defined with geometric precision, using user-specified shapes such as conical, elliptical, or polygonal regions, and can be directionally biased to restrict alerts to vehicles approaching from high-risk vectors. This feature prevents unnecessary activation in scenarios where vehicular movement does not intersect with pedestrian traffic, thereby conserving power, minimizing alert fatigue, and preserving system credibility among users. These zones are configurable through the administrative dashboard, and may also include exclusion areas, allowing sensors to ignore motion in non-critical regions such as employee-only driveways or private storage access points.

The system supports extensive parameter customization, allowing end-users to tailor alert behavior to match operational and environmental variables. Configurable parameters include but are not limited to detection sensitivity, vehicle speed thresholds, alert activation delays, and alert duration intervals. Time-based profiles can be established to reflect changes in site conditions throughout the day, such as reduced pedestrian activity during off-peak hours or increased sensitivity during shift changes or public access periods. Users may also define escalation logic, wherein the system increases alert intensity based on continued object movement, proximity reduction, or dual-mode detection involving both vehicle and pedestrian presence. Such logic can be embedded directly within the system firmware or managed externally through connected software systems, providing high flexibility without compromising operational reliability.

For advanced deployments, the system includes a programmable rule engine that supports conditional logic statements, enabling compound alert scenarios. For instance, an administrator may configure the system to initiate a first-level alert when a vehicle is detected within a ten-meter radius and a second-level alert if a pedestrian is also detected within five meters of the predicted vehicle path. These programmable conditions may be layered to produce complex behavior trees suited to highly dynamic environments, such as airport tarmacs, multi-level parking facilities, or active construction sites with concurrent pedestrian and vehicular circulation. In all cases, the system is designed to execute such logic deterministically and in real-time, ensuring that alerts are issued promptly and in accordance with predefined safety rules.

The Clear Path system is a highly adaptable pedestrian safety platform that leverages intelligent user interaction design, robust environmental adaptability, and deeply configurable alert logic to address the safety challenges inherent in modern vehicle-pedestrian interface zones. The system's ability to respond dynamically to variable site conditions, combined with its user-friendly configuration tools and scalable architecture, makes it suitable for deployment in a wide array of commercial and industrial contexts while maintaining high standards of effectiveness, reliability, and regulatory compliance.

The Clear Path Pedestrian Awareness System is purposefully designed with a modular architecture that enables extensive customization, seamless scalability, and straightforward adaptation to a diverse range of deployment conditions and use cases. Each core subsystem—comprising sensing, processing, alerting, power delivery, and communication functions—may be implemented as discrete, independently operable modules that communicate over a shared control interface. This structural modularity allows for selective activation, deactivation, or replacement of individual components without disrupting the system's overall functionality, thereby facilitating rapid installation, site-specific tailoring, and cost-effective maintenance procedures.

Modularity is further reflected in the device's layered integration model, wherein baseline configurations may be enhanced through the addition of auxiliary modules that extend the system's capabilities. For example, an entry-level configuration might include only motion sensors and basic LED visual alerts, suitable for deployment in low-risk or budget-constrained environments. This base system may subsequently be upgraded through the addition of advanced radar detection units, voice-capable auditory subsystems, ambient condition monitors, or cloud-connected communication modules, depending on evolving site requirements. The physical design of each module employs standardized connectors, mountings, and enclosures, allowing tool-less installation and ensuring mechanical compatibility across different hardware generations and third-party accessory ecosystems.

Expandability is also embodied in the system's firmware and software frameworks, which support over-the-air updates, third-party integration APIs, and flexible configuration schemas. As new features are developed or new detection algorithms become available—such as AI-driven pedestrian intent modeling, directional motion prediction, or thermal image processing—these capabilities can be added via remote software deployment without requiring physical hardware modifications. In embodiments incorporating local storage or edge computing, these software modules may reside within field-upgradeable storage units, which can be swapped or expanded as system demands grow. This extendable software foundation ensures that the Clear Path system remains technologically current and compliant with emerging safety regulations, performance benchmarks, and site-specific risk profiles.

Alternative embodiments of the Clear Path system are contemplated to support a range of operational settings and regulatory environments. In one embodiment, the system may be deployed in a low-profile, embedded configuration, wherein detection and alert components are integrated directly into architectural structures such as curb edges, bollards, traffic control arms, or existing signage. This form factor is particularly beneficial in aesthetic-sensitive urban environments or in locations where above-ground obstructions are undesirable. In another embodiment, the system may be adapted for mobile deployment, mounted on temporary structures such as scaffolding, portable barricades, or trailers, and used at transient construction sites or event venues where safety infrastructure must be rapidly deployed and retracted.

In further variations, the system may incorporate solar-hardened enclosures and autonomous energy management protocols, making it suitable for rural or remote-area deployment where electrical grid access is unavailable or unreliable. In such configurations, the power management module intelligently regulates charge and discharge cycles, leveraging real-time environmental inputs (e.g., solar irradiance levels, temperature, and battery state of charge) to ensure uninterrupted system functionality. Additionally, variants of the system may support environment-specific sensing arrays, such as LIDAR for precision distance mapping in complex, multi-level garages, or computer vision cameras trained to detect site-specific hazards such as forklift traffic or atypical vehicle forms.

Another contemplated embodiment includes integration with biometric or access control systems, wherein pedestrian proximity alerts may be cross-referenced with badge swipes, facial recognition data, or mobile device authentication. Such integration would allow the system not only to trigger alerts but also to restrict or permit physical access based on real-time safety assessments, thereby enabling a holistic safety-access framework. In still other embodiments, the system may be incorporated into a larger fleet management or site automation ecosystem, allowing data collected by the Clear Path sensors to inform traffic flow optimization, worker scheduling, or predictive maintenance routines through machine learning algorithms operating within centralized analytics platforms.

Importantly, the modular and extendable nature of the system is underpinned by compliance with standardized communication protocols and mechanical interface specifications, ensuring forward compatibility and supporting future expansion without necessitating replacement of core infrastructure. This future-proofing is critical in large-scale or multi-phase deployment environments, where technological obsolescence, shifting regulatory mandates, or site reconfiguration may otherwise compromise long-term investment value. Moreover, the system's flexible embodiment strategy allows it to address unique geographic, environmental, and demographic variables without sacrificing the integrity or efficacy of its core safety function.

The Clear Path Pedestrian Awareness System represents a highly modular and expandable safety solution designed to evolve in concert with the operational and technological needs of its deployment environment. Whether implemented in permanent, semi-permanent, or mobile configurations, and regardless of whether integrated into minimal or fully augmented deployments, the system offers a robust, adaptable, and legally compliant platform for enhancing pedestrian awareness and minimizing risk in high-traffic vehicle interface zones.

In an enhanced embodiment, the pedestrian awareness system may be configured to incorporate one or more video camera units operatively linked to the system's processing and monitoring infrastructure. The purpose of this integration is to provide real-time visual confirmation, incident documentation, and an additional data layer for both automated decision-making and manual oversight. The camera may be mounted either co-located with the sensor module, the alert module, or at a strategic vantage point offering an unobstructed view of the vehicle-pedestrian interface zone.

Each video camera may be a fixed-position or pan-tilt-zoom (PTZ) unit and may support high-definition (HD) or ultra-high-definition (UHD) video resolution to ensure clear identification of vehicular and pedestrian movement. Infrared (IR) or low-light imaging capability may also be included for effective operation in low visibility conditions such as underground parking garages or nighttime construction zones. The camera system may operate in a passive surveillance mode—continuously recording ambient activity—or be configured to activate only upon the occurrence of predefined events such as vehicular approach, pedestrian detection, or manual activation of the interface button.

The video camera may communicate with the system's central processing unit (CPU) or an edge processor via a wired connection (e.g., Ethernet, PoE) or through a secure wireless link (e.g., Wi-Fi, 4G/5G). When an activation event is triggered, the system may initiate recording or live streaming of video content to an on-site storage device or a remote cloud-based platform. This visual data may be time-synchronized with sensor logs and alert activation events, thereby providing a complete incident record for auditing, compliance, or forensic analysis.

Furthermore, the system may include optional integration with a video management system (VMS), enabling remote access to live feeds, video analytics, and event tagging. In some embodiments, advanced image processing or artificial intelligence (AI) algorithms may be applied to the video feed to assist with object classification, behavioral analysis, or pedestrian trajectory prediction. These analytics may operate in parallel with sensor-based detection logic, allowing the system to validate sensor inputs or trigger alerts based on visual cues alone.

From a system configuration standpoint, the inclusion of the video camera does not interfere with the core functionality of the Clear Path system but rather enhances its reliability and evidentiary capability. The camera unit may draw power from the same source as the alert or sensor modules and may be enclosed in a weather- and vandal-resistant housing conforming to IP66 or NEMA 4X standards. Mounting hardware may include pole clamps, wall brackets, or articulated arms for adjustable positioning. The camera may also include anti-glare shielding and sun visors to prevent false exposures and ensure image clarity under varied lighting conditions.

Integration with video systems also facilitates proactive safety interventions. For example, a control room operator monitoring the video feed may issue remote alerts via the system's speaker module, override automated logic, or coordinate with security personnel to intercept potentially hazardous behavior. In certain embodiments, the video feed may be linked with facial recognition or badge-verification systems for access control synchronization, enabling context-aware permissions and automatic alerts based on individual credentials.

Accordingly, the integration of a video camera subsystem enhances the utility, accountability, and real-time responsiveness of the pedestrian awareness system. It transforms the system from a purely reactive safety tool into a comprehensive, data-rich situational awareness platform suitable for high-risk commercial environments requiring advanced monitoring and regulatory documentation capabilities.

### Detailed Description of Figures

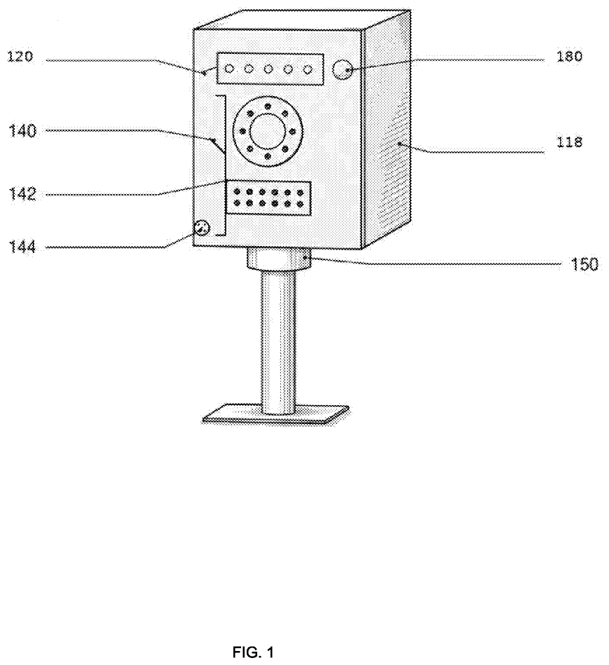

FIG. 1 depicts a user interface module configured to initiate or supplement the activation of the pedestrian awareness system. The module comprises a manual activation button mounted on the face of a weather-resistant enclosure having approximate dimensions of 2 13/16 inches in depth, 3 ½ inches in width, and 4 ½ inches in height. The button is constructed from high-durability, impact-resistant polymer, and is mechanically actuated to close an electrical circuit upon depression. The button may be configured with a momentary or maintained-contact switch, depending on deployment specifications, and is typically backlit to indicate system status (e.g., ready, active, or fault).

In certain embodiments, the button may be substituted with or complemented by a proximity sensor or motion detector, allowing for non-contact activation of the system. The optional sensor may employ passive infrared (PIR), ultrasonic, or radar technology and is mounted within the same enclosure or in an adjacent module communicatively coupled to the main unit. The enclosure includes mounting flanges or bracket interfaces to allow installation on poles, walls, or safety barricades. Wiring ingress is protected by gaskets or sealed conduit fittings to ensure compliance with ingress protection (IP) or National Electrical Manufacturers Association (NEMA) enclosure standards, such as IP65 or NEMA Type 4X.

The button/sensor module serves as a localized point of system interaction, enabling workers, pedestrians, or operators to manually trigger warning alerts or to supplement automated detection routines in high-risk or visually occluded areas. The module is electrically connected to the system's central control unit via low-voltage wiring or wireless communication protocol, and may include internal debounce logic to prevent false activations.

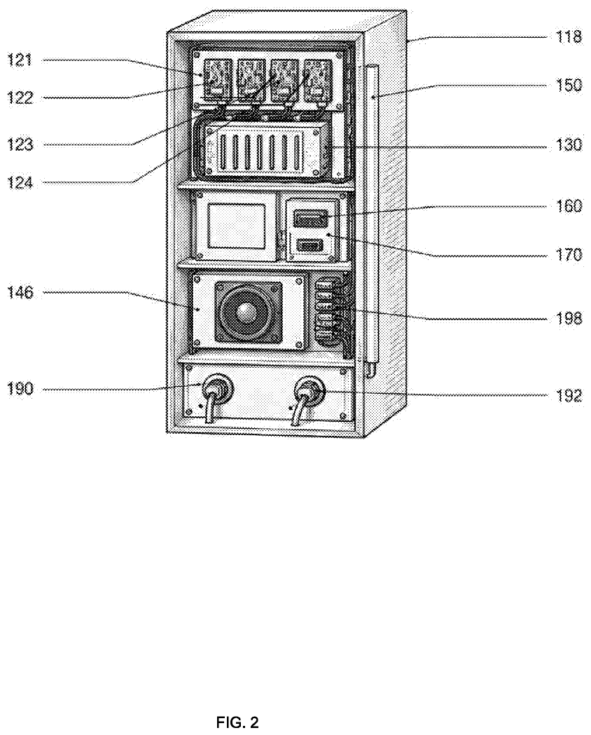

FIG. 2 shows an integrated alert unit comprising a high-visibility light element and an audible siren housed within a single enclosure. The housing measures approximately 6 inches in depth, 10 inches in width, and 8 inches in height, and is constructed from a high-impact, weather-sealed thermoplastic or powder-coated aluminum to protect internal components from mechanical stress, moisture, dust, and ultraviolet exposure. The visual alert component consists of a high-intensity LED beacon or strobe light, capable of emitting standardized color signals (typically red or amber) in flashing or steady illumination patterns. The LED module is mounted behind a diffused polycarbonate lens to optimize light dispersion and minimize glare.

The audible component includes an electronic siren or tone generator capable of producing a continuous or pulsed sound signal exceeding 90 decibels at 1 meter, with tone patterns programmable to conform to site-specific requirements or local safety codes. In some embodiments, the unit may also include a voice module capable of broadcasting pre-recorded or real-time voice alerts via a built-in speaker. Both the light and sound elements are triggered by control signals received from the processing unit in response to detected vehicular activity or manual activation via the interface module shown in FIG. 1.

Internally, the alarm housing contains mounting plates for the alert modules, a wiring terminal block, and optionally, a communication interface for integration with remote monitoring or control systems. The enclosure may include ventilation ports with mesh or acoustic dampers to maintain sound output while preventing ingress of particulate matter. Mounting options include wall brackets, pole adapters, or ceiling-mount frames, allowing for flexible deployment in construction sites, parking garages, and other commercial environments where visibility and audibility are paramount.

What is claimed is:

1. An autonomous pedestrian awareness system configured to alert pedestrians of vehicular activity within a designated hazard zone, the system comprising:
a. a sensor array configured to detect motion of vehicles approaching or departing a predefined pedestrian zone;
b. a processing unit operatively connected to the sensor array, the processing unit configured to analyze data received from the sensor array and identify motion patterns characteristic of vehicular activity;
c. an alert module comprising at least one visual alert mechanism and at least one audible alert mechanism, the alert module operatively connected to the processing unit and configured to activate in response to the detection of a vehicle within a predetermined proximity to the pedestrian zone;
d. a mounting assembly configured to support the sensor array and alert module at a site of installation;
e. and a power supply module configured to provide electrical power to the sensor array, processing unit, and alert module,
f. and an alarm housing containing mounting plates for the alert modules, a wiring terminal block, and a communication interface for integration with remote monitoring or control systems;
wherein the mounting assembly includes:
adjustable brackets configured to orient the sensor array in a user-defined direction and articulated arms for adjustable positioning; and
one or more of wall brackets, mounting flanges, pole adapters, ceiling-mount frames, modular brackets, support poles, or retrofit kits designed to integrate the device into pre-existing site infrastructure;
wherein the sensor array comprises one or more sensors selected from the group consisting of passive infrared sensors, ultrasonic sensors, millimeter-wave radar sensors, and optical image sensors, and wherein sensors are arranged in a linear, radial, or overlapping configuration to provide 180-degree or 360-degree surveillance coverage; and wherein the sensor array is mounted to structural support members via adjustable brackets that allow angulation and vertical calibration to optimize the detection field.

2. (canceled)

3. (canceled)

4. (canceled)

5. The system of claim 1, wherein the alert module includes a voice prompt generator configured to deliver audible verbal warnings in one or more languages.

6. (canceled)

7. (canceled)

8. The system of claim 1, wherein the system includes a communication interface module configured to transmit operational data to a remote monitoring platform via a wireless communication protocol, and wherein the system further comprises a video camera operatively coupled to the processing unit and configured to record or stream footage of the pedestrian zone upon detection of a vehicular event.

9. The system of claim 8, wherein the video camera is further configured to interface with a video management system and apply video analytics for object classification, behavioral prediction, or event tagging.

10. (canceled)

11. The system of claim 1, wherein the system is configured to automatically adjust the brightness of the visual alert mechanism in response to ambient light conditions.

12. The system of claim 1, wherein the audible alert mechanism is configured to adjust output volume based on ambient noise levels detected at the site of installation.

13. The system of claim 1, wherein the processing unit is further configured to detect the presence of pedestrians and modify alert behavior based on the concurrent detection of both pedestrians and vehicles.

14. The system of claim 1, wherein the system comprises modular components that are physically and electrically connectable through standardized connectors to facilitate field upgrades and replacement.

15. The system of claim 1, wherein the sensor array defines a configurable detection zone having a shape selected from the group consisting of a cone, a polygon, or a radial arc.

16. The system of claim 1, wherein the processing unit executes conditional alert logic based on compound detection scenarios comprising a combination of vehicle direction, pedestrian presence, and time of day.

17. The system of claim 1, wherein the system is configured for mobile deployment on temporary support structures selected from the group consisting of scaffolding, freestanding poles, and wheeled trailers.

18. The system of claim 1, wherein the system includes a software interface accessible via a remote device and configured to display system status, modify configurations, and initiate diagnostic routines.

19. (canceled)

20. The system of claim 1, wherein the system is integrated with an access control system and configured to restrict or enable passage through a gate or entry point based on vehicle detection events.

21. The system of claim 1, wherein a tone generator is capable of producing a continuous or pulsed sound signal exceeding 90 decibels at 1 meter with tone patterns programmable to conform to site-specific requirements or local safety codes.

22. The system of claim 1, wherein core subsystems comprising sensing, processing, alerting, power delivery, and communication functions are implemented to be independently operable and communicate over a shared control interface.

23. The system of claim 1, wherein volume levels are automatically modulated in response to ambient noise measurements obtained through integrated acoustic sensors and visual alerts are generated by high-intensity LED modules, which may be configured in various geometric arrays and programmed to flash in standardized color sequences, wherein time-based profiles are established to reflect changes in site conditions throughout the day.

24. The system of claim 1, wherein auditory alerts are generated using high-decibel buzzers and pre-recorded voice prompts with the added capability of utilizing a synthesized speech engine to articulate dynamic warnings.

25. The system of claim 1, wherein alert events are tied into fire control panels, evacuation systems, or mobile notification platforms and through its flexible input/output (I/O) architecture the system is interfaced with external actuators, gate controllers, CCTV systems, and audible public address networks.

26. The system of claim 1, wherein bidirectional safety logic modulates the alert to both parties by cross-referencing of pedestrian and vehicle position data.
